(19) United States
(12) Patent Application Publication
(10) Pub. No.: US 2003/0197425 A1
(43) Pub. Date: Oct. 23, 2003

(54) Dual input voltage adapter system and method

(76) Inventor: Charles J. Montante, Brookfield, WI (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/310,376

(22) Filed: Dec. 5, 2002

Related U.S. Application Data
(60) Provisional application No. 60/336,915, filed on Dec. 5, 2001.

(51) Int. Cl. H02J 3/02; H02J 3/04; H02J 3/38

(52) U.S. Cl. 307/26

(57) ABSTRACT

A voltage adapter for use with DC operable devices and for deriving a DC output voltage from either an AC voltage power source or a DC voltage power source. The voltage adapter, which is selectively coupled by a cable assembly to either a DC voltage power source or an AC voltage power source, includes separate voltage regulators for regulating a DC output voltage derived from the AC voltage and a DC output voltage derived from the DC voltage. The voltage adapter also allows selection of the amplitude for the DC output voltage within a range.

### BACKGROUND OF THE INVENTION

### FIELD OF THE INVENTION

This invention relates to power supplies, and more particularly, to a voltage delivering system that derives a DC output voltage from AC and DC voltage inputs.

Today's laptop computers have just as much computing power as desktop computers, without taking up as much space. A user can take a laptop on the road to do work or make presentations. A user may prefer working on the couch in front of a television instead of sitting at a desk. On the other hand, a user may want to use a laptop while travelling in an airplane or to make use of the flight time for doing work.

As useful and convenient as a laptop can be, there is one component that is vital to the operation of a laptop—it is the power supply. The power supply converts the alternating current (AC) line from the user's home, or any other power sources to the direct current (DC) needed by the laptop.

Power supplies convert an AC supply voltage to a lower DC voltage. The typical voltages supplied are 3.3 volts, 5 volts, and 12 volts. In the past, power supplies tended to be heavy and bulky. They used large, heavy transformers and huge capacitors to convert line voltage at 120 volts and 60 hertz into 5 volts and 12 volts DC. The switching power supplies used today are much smaller and lighter. They convert the 60-Hertz (Hz, or cycles per second) current to a much higher frequency. This conversion enables a small, lightweight transformer in the power supply to do the actual voltage step-down from 110 volts (or 220 in certain countries) to the voltage needed by the particular computer component. The higher-frequency AC current provided by a switcher supply is also easier to rectify and filter as compared to the 60-Hz AC line voltage, reducing the variances in voltage for the sensitive electronic components in the computer.

AC adapters are well known in the art. For example, U.S. Pat. Nos. 5,698,964 and 5,864,457 disclose AC adapters for use with DC voltage operable devices. Furthermore, U.S. Pat. No. 6,172,891 issued to O'Neal, discloses an AC voltage adapter with an integrated DC voltage power connector that allows the AC voltage adapter to be connected to either an AC power supply or a DC power supply. The dual input (AC and DC) voltage adapter disclosed by O'Neal includes a voltage switch for establishing an open circuit between the DC voltage operable device and the remote DC voltage power supply when an AC power source is connected to the voltage adapter. O'Neal's voltage adapter utilizes a single voltage converter, a common voltage regulator, and a single voltage switch and is designed specifically for use with an in-seat power source for an airplane.

In-seat airplane power sources typically supply 15 volts DC. Dell Computer Corporation laptops, in particular, operate within the range of 8 volts to 19 volts and therefore do not need regulation when drawing power from known in-seat airplane power sources.

However, none of these current solutions teach a dual input voltage adapter with a selectable DC output. Selectable DC output voltage increases the versatility of the voltage adapter. Moreover, today's AC and DC power sources can output a wide range of AC and DC voltages. Hence, there remains a need for a versatile power supply that can be electrically connected to any AC or DC power sources for deriving regulated DC voltages.

Accordingly, it is the primary objective of the present invention to provide a voltage delivery system for deriving a DC output voltage from AC and DC power sources.

Another objective of the present invention is to provide a voltage delivery system that allows selection of the amplitude of the DC output voltage.

It is yet further an objective of the present invention to provide a voltage adapter including an AC-DC converter including a continuous current mode flyback converter for deriving output voltage from an AC input voltage, and a DC-DC converter including a voltage mode boost converter for deriving a DC output voltage from a DC input voltage.

The voltage delivery system of the present invention must also be of construction which is both durable and long lasting, and it should also require little or no maintenance to be provided by the user throughout its operating lifetime. In order to enhance the market appeal of the apparatus of the voltage delivery system, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the voltage delivery system of the present invention. This invention provides a single-output isolated continuous current mode flyback converter for the AC input and a voltage mode boost converter for the DC input with selectable DC output voltage. Both converter outputs can be fed to a bank of capacitors. The voltage delivery system features a wide range of AC inputs, EMI filtering, overcurrent protection, overvoltage protection, dual pulse-width modulation, and an output indicator.

In one embodiment, the voltage delivery system includes a voltage adapter and cable assemblies that can be electrically coupled to a DC operable device, such as a laptop, a PDA, or other mobile computer, to provide DC power to the DC operable device. For example, one cable assembly can electrically couple the voltage adapter to a DC voltage power source while another cable assembly can electrically couple the voltage adapter to an AC voltage power source. In an alternate embodiment of the invention, a single cable assembly can be capable of electrically coupling the voltage adapter to an AC or DC voltage source.

The voltage delivery system of the present invention comprises a voltage adapter for deriving a DC output voltage from either an AC voltage power source or a DC voltage power source; a first cable assembly for electrically coupling the voltage adapter to the DC voltage power source; a second cable assembly for electrically coupling the voltage adapter to assembly AC voltage power source; and a third cable assembly for electrically coupling the voltage adapter to the DC voltage operable device. The voltage adapter further includes a first voltage regulator for regulating a DC output voltage derived from the AC voltage and a second voltage regulator for regulating a DC output voltage derived from the DC voltage.

In another embodiment, the voltage adapter of the present invention further comprises a feedback circuit for deriving from the DC output voltage feedback signal for controlling the first voltage regulator and the second voltage regulator, wherein the first voltage regulator includes a first switching device and a first pulse-width modulator for providing a drive signal for the first switching device and the second voltage regulator includes a second switching device and a second a pulse-width modulator for providing a drive signal for the second switching device; a DC output circuit portion adapted to allow the selection of the amplitude of the DC output voltage; an overvoltage protection portion for disabling at least one of the voltage regulators whenever the amplitude of the DC output voltage exceeds a pre-determined value; a common feedback circuit for deriving from the DC output voltage, feedback signals for the first pulse-width modulator and the second pulse-width modulator; a voltage boosting converter portion for boosting the amplitude of a DC input voltage from the DC voltage power source to a higher amplitude in deriving the DC output voltage; a first in-rush current limiter for reducing in-rush current due to AC input voltage and a second in-rush current limiter for reducing in-rush current due to DC input voltage.

In one preferred embodiment, a DC output circuit allows for selection of the amplitude for the DC output voltage within a range, preferably about 15 volts DC to 25 volts DC.

In another embodiment, the voltage adapter provides a selectable DC output voltage by providing means for adjusting the resistive value at the DC output. Alternatively, the DC output voltage may be controlled and adjusted at the booster portion of the voltage adapter rather than the output portion of the voltage adapter. The selection of DC output voltage may be pre-selected at the time the voltage adapter is manufactured or a means for manually adjusting the DC output voltage may be provided with the voltage adapter. The voltage adapter also provides an analog or digital means for facilitating the selection of the DC output voltage. The analog means may include a rotary dial with varying resistive values; the digital means may include an analog-to-digital (A/D) support circuitry to help the user adjust the DC output voltage and a visual readout support circuitry to help the user read the DC output voltage.

The voltage delivery system further provides a dual input voltage adapter for use with a DC voltage operable device. The dual input voltage adapter comprises means for electrically coupling the dual input voltage adapter to an AC voltage power source; means for electrically coupling the dual input voltage adapter to a DC voltage power source; means for electrically coupling the dual input voltage adapter to a DC voltage operable device; means for deriving a DC output voltage from either the AC voltage power source or DC voltage power source for delivering the DC output voltage to the DC operable device; and means for selecting the amplitude of the DC output voltage.

The voltage delivery system further provides a method of supplying DC voltage to a DC operable device, comprising the steps of selectively coupling a cable assembly from a voltage adapter to either a DC voltage power source or an AC voltage power source; coupling the voltage adapter to the DC voltage operable device; regulating a DC output voltage derived from the AC voltage using a first voltage regulator and regulating a DC output voltage derived from the DC voltage using a second voltage regulator; selecting an amplitude for the DC output voltage and delivering the selected DC output voltage amplitude to the DC voltage operable device. The method further comprises the step of optically coupling a feedback signal from a feedback circuit to one of said voltage regulators.

It may therefore be seen that the voltage delivery system teaches a device for use with DC operable devices and provides a dual input, single-output output voltage adapter wherein the amplitude of the DC output voltage is selectable. In one embodiment, the voltage delivery system teaches a voltage adapter and cable assemblies that can electrically couple a DC operable device to an AC and/or a DC voltage source to provide DC power to the DC operable device. In an alternate embodiment, a single cable assembly can electrically couple the voltage adapter to an AC or a DC voltage source. The voltage delivery system of the present invention also features a voltage adapter that can respond to a wide range of AC or DC voltage inputs, and provides EMI filtering for the AC or DC input voltage, overcurrent protection, and overvoltage protection. In one embodiment, the voltage adapter is a 75 watt single output isolated continuous current mode flyback converter for an AC input and a voltage mode boost converter for the DC input. In another embodiment, the voltage adapter features a wide range of AC input (90-264 V AC).

The apparatus of the voltage delivery system is of a construction which is both durable and long lasting, and which will require little or no maintenance to be provided by the user throughout its operating lifetime. The apparatus of the voltage delivery system is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the voltage delivery system of the present invention are best understood with reference to the drawings, in which:

FIG. 1 is a simplified representation of a voltage delivery system of the present invention, connectable to an AC voltage source or a DC voltage source and for converting an AC voltage or a DC voltage to a regulated DC voltage for application to a DC operable device.

FIG. 2 is a block diagram of a voltage adapter of the voltage delivery system in accordance with one embodiment of the present invention.

FIGS. 3-5, when arranged as. shown in FIG. 6, are a schematic diagram of the voltage adapter of FIG. 2.

FIG. 6 shows how FIGS. 3-5 are to be arranged.

FIG. 7 is a schematic diagram showing an alternate embodiment of an isolating device of FIG. 4.

### DETAILED DESCRIPTION OF THE PREFERRED EMBODIMENT

The preferred embodiment of a voltage delivery system according to the invention features voltage adapter including an AC to DC converter and a DC to DC converter which enable the voltage adapter to be connected to derive from AC and DC sources, a regulated DC voltage for a DC voltage operable device. The DC voltage produced by both the AC-to-DC converter and the DC-to-DC converter are applied to a common voltage storage system. The voltage adapter includes separate voltage regulation systems for the AC to DC converter and the DC to DC converter such that regulation of the DC voltage is not required after the converter stages. Moreover, the voltage adapter automatically responds to either an AC voltage input or a DC voltage input to produce a regulated DC output voltage without the need for a switching device such as a relay to isolate the output of the AC to DC converter from the output of the DC to DC converter. In addition, the amplitude of the regulated DC voltage produced by the voltage adapter of the present invention can be adjusted to be set to any value within a range of values, allowing the voltage adapter to provide a regulated DC output voltage designed to match the requirements of a DC voltage operable device with which the voltage adapter is being used. The capability of selection of the amplitude of the DC output voltage so that the DC output voltage provided by the voltage adapter can be preset at any amplitude within a given range increases the versatility and utility of the device.

Overview

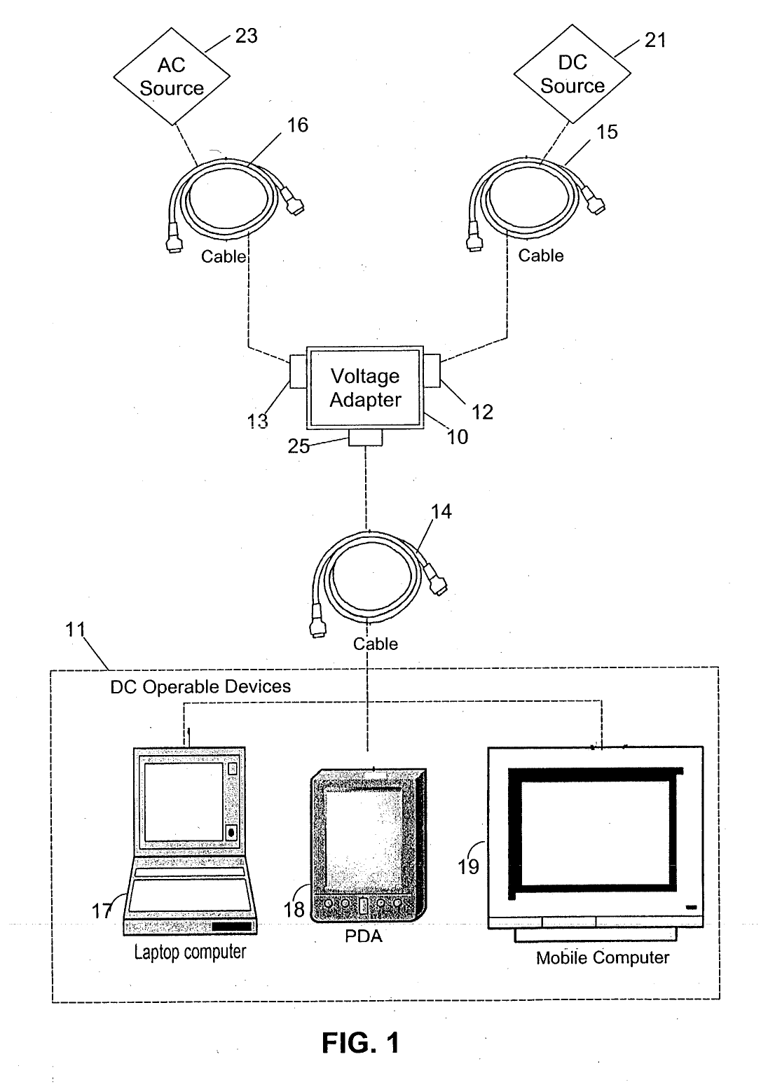

Referring to FIG. 1 of the drawings, the voltage delivery system according to the present invention includes a voltage adapter 10 and cable assemblies 14, 15, and 16. FIG. 1 illustrates how the voltage adapter 10 can be connected to DC voltage operable devices 11 and DC and AC power sources, 21 and 23, respectively. By way of example, the DC voltage operable devices 11 can be a laptop computer 17, a personal digital assistant (PDA) 18, a mobile computer 19, or any other device that requires a DC voltage for operation. As is stated above, the voltage adapter 10 can receive power from a source 21 of DC voltage or a source 23 of AC voltage and derive from such sources, a regulated DC voltage for application to the DC voltage operable devices 11.

As shown in FIG. 1, a DC supply input 12 of the voltage adapter 10 can be connected to a source 21 of DC voltage by a cable assembly 15 having a plug or connector at each end, the plug or connector at one end being adapted for connection to the DC voltage source 21 and the plug or connector at the other end being adapted for connection to the DC input 12 of the voltage adapter 10. Alternatively, an AC supply input 13 of the voltage adapter 10 can be connected to an AC voltage source 23 of AC voltage by a cable assembly 16 that has a plug or connector at one end adapted for connection to the AC voltage source 23 and a plug or connector at the other end adapted for connection to the AC input 13 of the voltage adapter 10.

By way of example, the DC voltage source can be a cigarette lighter outlet in a car or other vehicles, an in-seat outlet in an airplane, or a DC outlet on a boat. The DC voltage source preferably can provide a regulated DC voltage at 10 to 16 volts DC. However, if the DC voltage source 21 provides an unregulated DC voltage, the voltage adapter 10 can regulate the DC voltage provided by the DC voltage source.

The AC voltage source can be a conventional 50/60 Hz, 90/264 VAC available at a wall outlet and the like, and the cable assembly 16 can be a power cord with a plug or connector that mates with the AC input 13. The output of the voltage adapter 10 can be connected to a DC voltage operable device 11 by a cable assembly 14 that is adapted for connection to an output 25 of the voltage adapter 10 and an input of the DC voltage operable device 11.

The cable assemblies 15 and 16 may be used in combination with varying types of AC and DC power sources. For example, if the voltage adapter 10 is used in a car, cable assembly 15 includes an auto socket adapter to be used in combination with a cigarette lighter socket. Such auto socket adapter can further be used in combination with an airplane cord adapter, such as an EmPower Socket Connector, which connects to an airplane plug to provide DC power to the voltage adapter 10. Similarly, cable assembly 16 can be used in combination with other universal voltage plugs to connect to AC sources in different countries.

As is stated above, the voltage adapter 10 can be connected to either a DC source or an AC source for producing a regulated DC voltage. The voltage adapter 10 automatically responds to a DC voltage applied to the DC input 12 or to an AC voltage applied to the AC input 13 to produce the regulated DC output voltage.

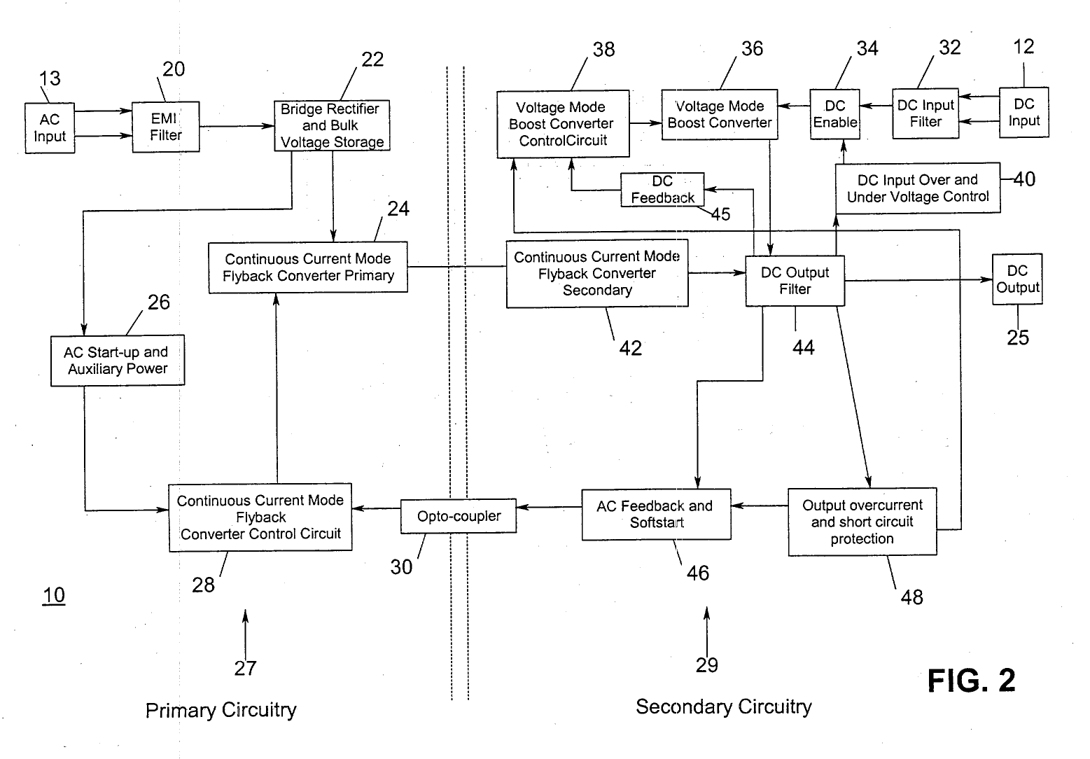

FIG. 2 is a block diagram of the voltage adapter 10 in accordance with one embodiment of the present invention. The voltage adapter 10 includes an AC section 27 and a DC section 29. The AC section 27 and the DC section 29 include primary winding circuitry and secondary winding circuitry, respectively, of an AC to DC converter of the voltage adapter 10, as will be described.

Referring first to the AC section 27, the voltage adapter 10 includes input circuits including an EMI filter 20 and a bridge rectifier 22. The EMI filter 20 is class B compliant, as defined by the Federal Communications Commission (FCC) regarding limits on radio frequency (RF) emissions from products in residential environment. The voltage adapter further includes an AC to DC converter, which in one embodiment includes a continuous current mode (CCM) flyback converter circuit that includes a CCM flyback converter primary 24, a CCM flyback converter secondary 42 (which is a component of the DC section 29) and a CCM flyback converter control circuit 28. The voltage adapter 10 further includes an AC start-up and auxiliary power circuit 26.

Referring now to the DC section 29, the voltage adapter 10 includes a DC input filter 32, a DC enable circuit 34, and a DC to DC converter. In one embodiment, the DC to DC converter includes a voltage mode boost (VMB) converter circuit including a VMB converter 36 and a VMB control circuit 38. The voltage adapter 10 further includes a DC input over/under voltage control 40, an output overcurrent/short circuit protection circuit 48, a DC feedback circuit 45, an AC feedback and softstart circuit 46 and a DC output and filter circuit 44. As is stated above, the CCM flyback converter secondary 42 is a component of the DC section 29. In addition, the voltage adapter 10 includes opto-coupler 30 that couples a feedback signal produced by the AC feedback and softstart circuit 46 of the DC section 29 to the AC section 27.

AC Section

The EMI filter 20 of the AC section 27 filters the AC input voltage when the voltage adapter 10 is connected to the AC voltage source 23 (FIG. 1). Electromagnetic interference (EMI) can disrupt the operation of electric and electronic equipment. The EMI filter 20 controls EMI of the preferred embodiment and reduces the amount of radiated noise escaping out of the line cord or cable assembly 16 (FIG. 1). The EMI filter 20 also reduces the common mode conducted emissions and differential mode noise to help shield DC operable devices 11 from harmful EMI and reduce EMI emissions.

The rectifier circuit 22 provides full wave rectification of the AC input voltage when the voltage adapter 10 is connected to the AC source 23.

The rectifier circuit 22 further provides in-rush current limiting protection for the voltage adapter 10, components of which heat and cool each time the voltage adapter 10 is turned on or off, and receive the first in-rush of AC current when a DC operable device 11 obtaining DC power from the voltage adapter 10 is switched on. To this end, the bridge rectifier 22 includes an in-rush current limiter, also known as a surge limiter. In-rush current limiting protection extends the life of the voltage adapter 10.

The AC start-up and auxiliary power circuit 26 provides power for converter control circuits. Before a switching power supply can supply power, it must itself be powered. In one embodiment, the AC start-up and auxiliary power circuit 26 provides power for the CCM flyback converter control circuit 28. In one embodiment, to minimize startup supply power loss, AC start-up and auxiliary power circuit 26 turns off the startup supply when the main supply begins operating. The main supply provides control power through an auxiliary output on the primary side of the converter transformer. This auxiliary supply parallels the startup supply output. In the preferred embodiment, active startup supply is implemented, which means that the startup supply turns off after startup, allowing the more efficient auxiliary supply to operate solely, thereby significantly increasing overall efficiency. However, it is fully contemplated that a passive startup supply can also be implemented where the startup supply is operated all the time, thereby eliminating the need for the auxiliary supply.

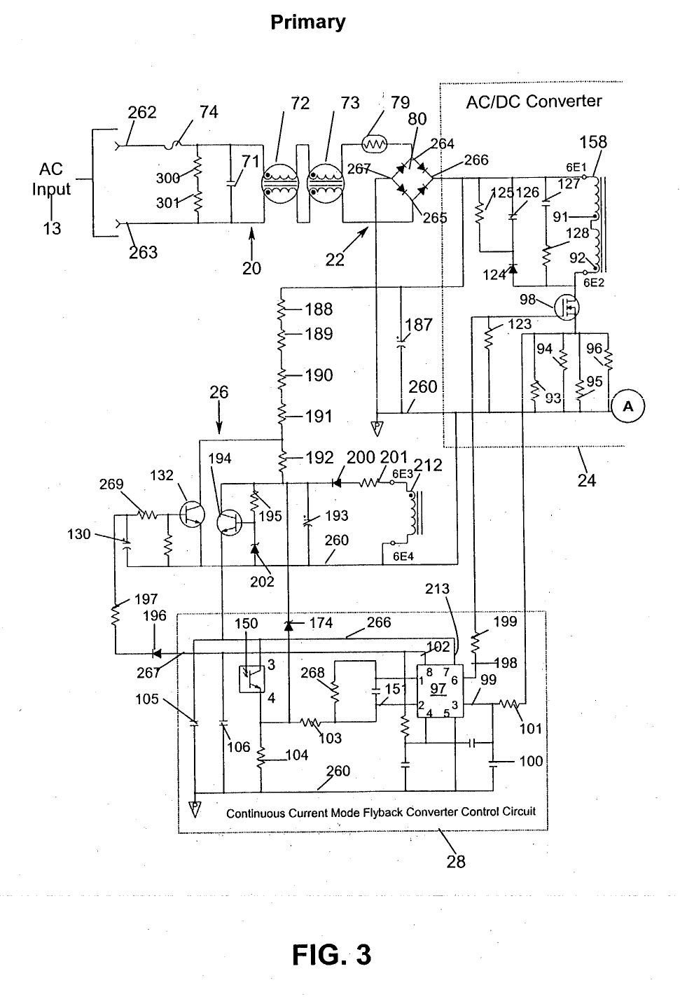

The AC to DC conversion is provided by the continuous current mode (CCM) flyback converter circuit. The CCM flyback converter includes a primary winding 24, a secondary winding 42 and a CCM flyback converter control circuit 28. The CCM flyback converter is a switching DC/DC converter. The CMM flyback converter control circuit 28 includes a pulse-width modulator (PWM) 97 (FIG. 3) that drives a switching device 98 (FIG. 3) connected in series with the primary winding to store energy in the primary during a first portion of each AC cycle and to cause the stored energy to be transferred to the secondary winding during a second portion of each AC cycle. The control is such as to produce a regulated DC voltage in the DC section 29 of the voltage adapter 10.

The PWM, which is the heart of the AC input supply and the CCM flyback converter control circuit 28, employs square-wave pulse-width modulation to achieve voltage regulation. As will be shown, in one embodiment, the VMB converter control circuit 38 of the voltage adapter 10 also employs a pulse-width modulator for regulating DC voltages. Thus, the voltage adapter 10 employs first and second pulse-width modulators to help regulate the DC output voltage provided by the voltage adapter 10. This is an important feature because it allows the voltage adapter 10 to accommodate a wide range of inputs/outputs where the current demand on the power supply or the charging system's supply voltage is not constant. In one embodiment, the AC input voltage can be 50/60 Hz, 90/264 VAC and the regulated DC output voltage can be set to a value in the range of about 15 volts to 25 VDC, for example. However, the voltage adapter 10 can be adapted to receive an AC input voltage less than 90 VAC or greater than 264 VAC and can be adapted to produce a regulated DC voltage at values greater than 25 VDC or less than 15 VDC with appropriate modifications which known to those skilled in the art.

DC Section

The DC input filter 32 filters the DC input voltage supplied from the DC input 12 of the voltage adapter 10 when the voltage adapter 10 is connected to a DC voltage source. The DC input filter 32 also provides protection against transients.

The DC enable circuit 34 is interposed between the output of the DC input filter and the input of the DC to DC converter and disconnects the input of the DC to DC converter from the DC voltage input in the event of an under/overvoltage condition for the DC input voltage or overcurrent condition for the DC output.

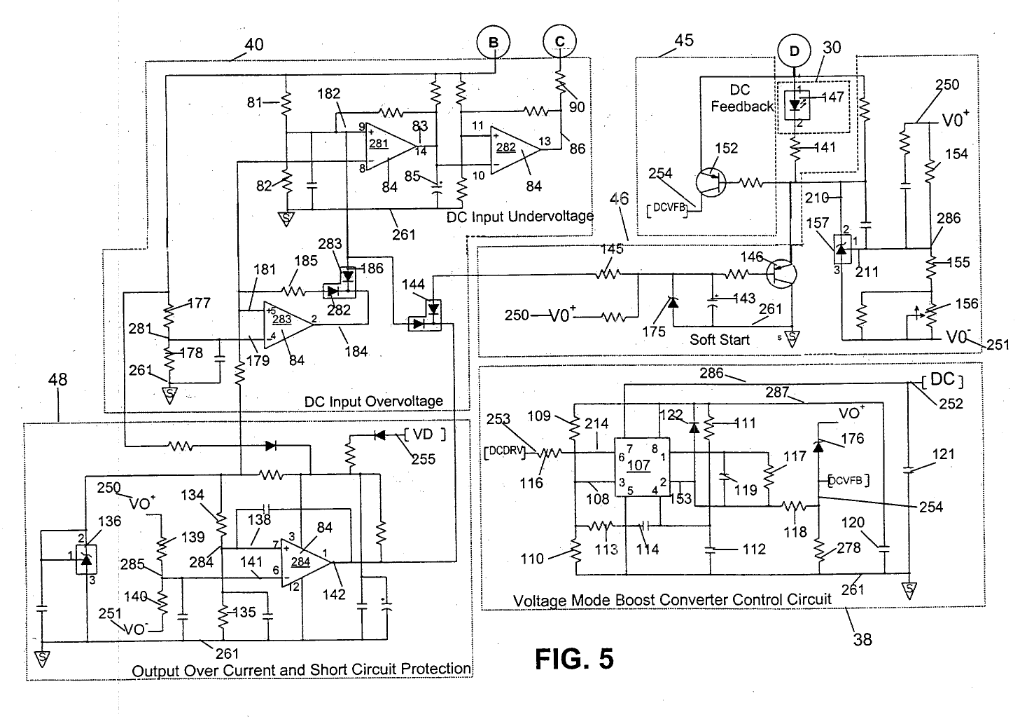

The DC to DC conversion is provided by the VMB converter 36 (or step-up converter) which includes a switching device connected in circuit with an inductive load. The VMB control circuit 38 includes a pulse-width modulator 107 (FIG. 5) that drives the switching device. The VMB converter 36 is a switching DC/DC converter that produces an output voltage greater than the source. This is especially important when the voltage adapter 10 is used to supply DC voltage to a laptop computer the electronic circuits of which requires a higher operating voltage than typical DC sources can supply.

The DC input over/under voltage control 40 is a supervisory circuit of the voltage adapter 10. Overvoltage protection disables the voltage adapter 10 if the voltage exceeds a certain limit. This aids in preventing DC operable devices 11 from being overloaded and damaged. DC input undervoltage protection monitors the DC input, voltage and disables the voltage, adapter 10 if the input voltage “dips” lower than a preset voltage.

The DC output overcurrent/short circuit protection circuit 48 also provides a supervisory function by monitoring current in the output circuit to detect short circuit and overcurrent conditions. A short circuit condition results in the voltage adapter shutting down. Overcurrent condition are suppressed by internal regulation functions of the voltage adapter 10 which prevent the output current from exceeding a preset current limit.

The DC feedback circuit 45 and the AC feedback and softstart circuit 46 provide feedback signals for the pulse-width modulator 107 of the DC section 29 and the pulse-width modulator 97 of the AC section 27, respectively. The feedback signal for controlling the pulse-width modulator 97 is coupled to the AC section 27 by opto-coupler 30 to maintain isolation between the AC and DC sections of the voltage adapter 10.

The DC output and filter circuit 44 includes a voltage storage mechanism which, in one embodiment, is a bank of capacitors. The regulated DC voltage produced by the AC to DC converter (the CCM flyback converter) and the regulated DC voltage produced by the DC to DC converter (the VMB converter) are applied to these capacitors. The regulated DC output voltage is taken from these capacitors. An isolating device provides isolation between the output of the AC to DC converter and the output of the DC to DC converter at the input to the DC output and filter circuit.

In addition, as will be described, the DC output and filter circuit 44 includes an output voltage amplitude selection network that allows the amplitude of the DC output voltage to be adjusted within a range, so the amplitude of the output voltage can be selected.

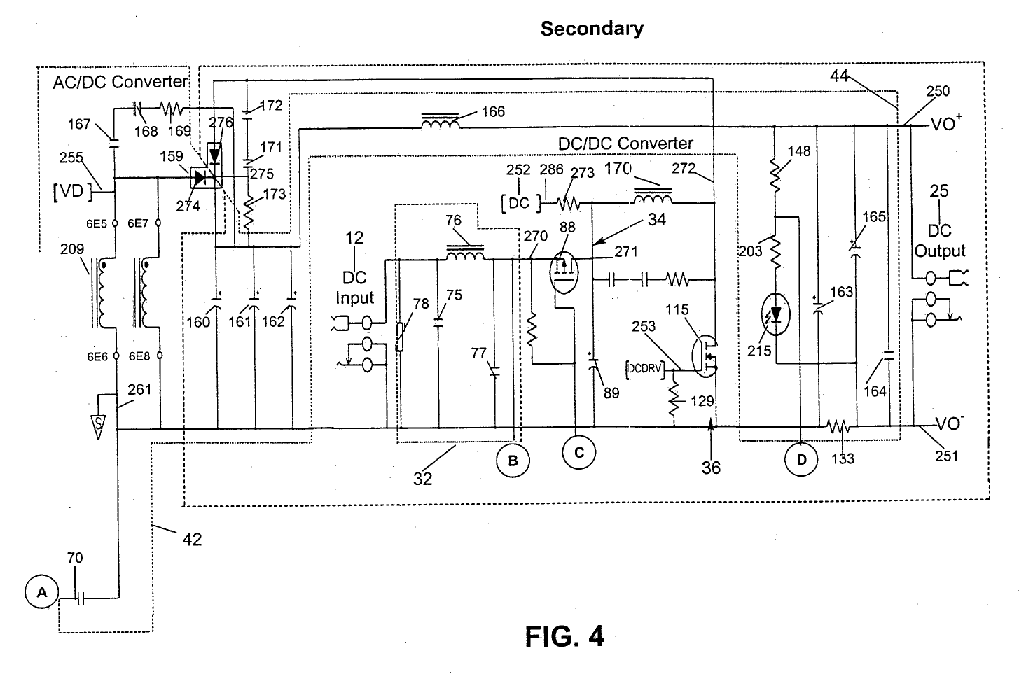

The CCM flyback converter, including the CCM flyback converter control circuit 28, the CCM flyback converter primary 24 and the CCM flyback converter secondary 42, derive a fixed DC voltage from an AC input voltage and provide continuous protection for the switching device 98 and inherent overload protection for the voltage adapter 10. In one embodiment, the flyback converter operates in continuous current mode in which some energy stored in the secondary winding 209 (FIG. 4) during a given cycle remains in the secondary winding 209 at the beginning of the next cycle. Current mode control is preferred because it provides superior bandwidth and transient response, in addition to cycle-by-cycle current limiting.

Both the AC section 27 and the DC section 29 implement an input-current-limiting feature. The preferred embodiment employs input current limiting to reduce the cost of the voltage adapter used with mobile computers while meeting the power requirements of the mobile computer and charging the batteries. In one embodiment, the DC input voltage can be 10 volts to 16 VDC and the regulated DC output voltage can be set to a value in the range of about 15 volts to 25 VDC, for example. However, the voltage adapter 10 can be adapted to accept higher or lower values of DC input voltage and can be adapted to produce a regulated DC voltage at values less than 15 VDC or greater than 25 VDC with appropriate modifications which known to those skilled in the art. In addition, the voltage adapter 10 can be adapted to produce a regulated DC output voltage if the input voltage is greater then 25 VDC, such modifications is known to those skilled in the art. For example, in such embodiment, a voltage booster function may be not be required.

### DETAILED DESCRIPTION

AC Section Components

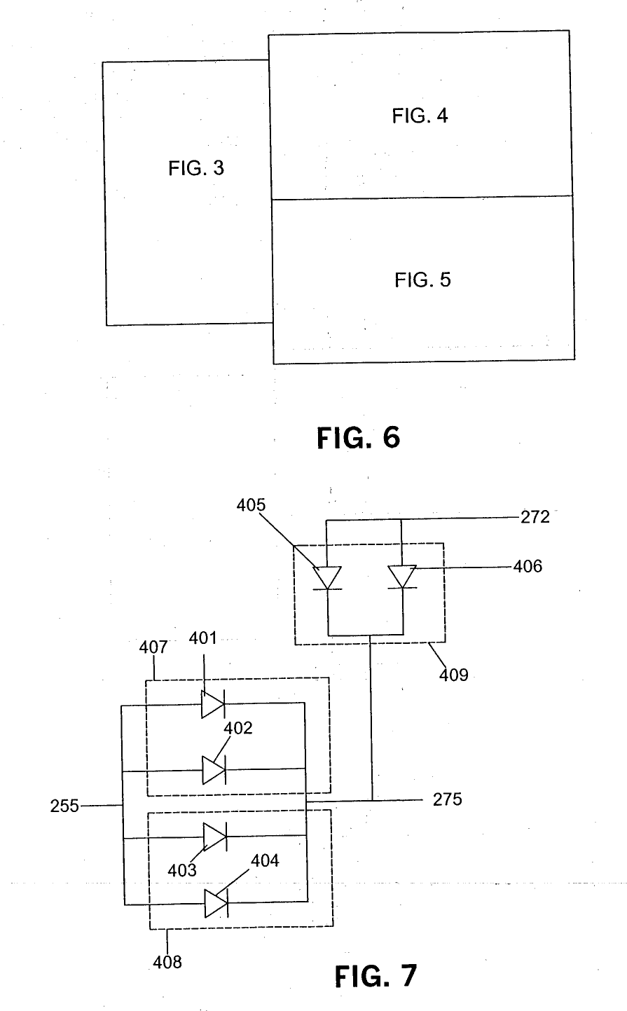

FIGS. 3-5, when arranged as shown in FIG. 6, are a schematic circuit diagram of the voltage adapter of the voltage adapter 10. More specifically, the schematic circuits of FIGS. 3 and 4 are interconnected via nodes A. The schematic circuits of FIGS. 4 and 5 are interconnected via nodes B, C, and D. The AC section 27, which includes the primary circuitry, is shown in FIG. 3 and the DC section 29, which includes the secondary circuitry, is shown in FIGS. 4 and 5.

To improve readability and organization of the circuits of the present invention, the schematic circuits of FIGS. 3-5 are further divided into sections corresponding to the blocks shown in the block diagram of FIG. 2. For example, FIG. 3 contains the schematic circuits for blocks 20, 22, 24, 26, 28, and the output portion (transistor 150) of the opto-coupler 30 of FIG. 2. FIGS. 4 and 5 contain the schematic circuits for blocks 32, 34, 36, 38, 40, 42, 44, 45, 46, 48, and the input portion (light emitting diode 152) of the opto-coupler 30 of FIG. 2.

Referring to FIG. 3, the EMI filter 20 includes a bypass capacitor 71, resistors 300 and 301, chokes 72 and 73, and a capacitor 70, shown in FIG. 4. The bypass capacitor 71, which is connected between the line input conductor 262 and the ground (or Y) input conductor 263, reduces common mode conducted emissions. Resistors 300 and 301 are connected in parallel with capacitor 71. Capacitor 70, which is connected between the common conductor 260 for the circuits of the AC section 27 and the common conductor 261 (FIG. 4) for the circuits of the DC section 29, reduces differential mode noise. A differential capacitor (not shown) may also be connected in parallel to capacitor 71 and interposed between chokes 72 and chokes 73 to provide a tunning means for the AC input.

The chokes 72 and 73 couple the output of the EMI filter 20 to the input of the rectifier circuit 22. The chokes 72 and 73, which have a common core, minimize both common mode and differential mode noise. A fuse 74 can be connected in series with the line input conductor 262 to protect the circuits of the voltage adapter 10 against abnormal conditions.

The rectifier circuit 22 includes a full wave bridge rectifier 80 having its input terminals 264 and 265 connected across the output of the input EMI filter 20 and its outputs 266 and 267 connected between one side of the primary winding 158 of the transformer (at terminal 6E1) and the primary common conductor 260.

In one embodiment, the in-rush current limiter is a negative temperature coefficient (NTC) thermistor 79 which is connected between the output of the EMI filter 20 and terminal 264 of the bridge rectifier 80 to limit input surge current into the bridge rectifier 80. In one embodiment, the thermistor 79 is a thermistor with a varying resistance between 2 ohms to 10 ohms.

The output of the bridge rectifier 80 is connected to the primary winding 158 of the transformer of the AC to DC converter which includes the CCM flyback converter primary 24, the CCM flyback converter secondary 42 and the CCM flyback converter control circuit 28. The transformer includes split primary winding 158, dual, parallel-connected secondary windings 209, which are part of the CCM current mode flyback converter secondary 42 (FIG. 4) and an auxiliary winding 212 which is part of the AC start-up and auxiliary power circuit 26.

Referring first to the CCM flyback converter primary 24, the primary winding 158 is connected in series with a switching device 98, and current sense resistors 93-96 between the output terminal 266 of the bridge rectifier 80 and the primary common 260. In the preferred embodiment, the switching device 98 is a field effect transistor (FET). The preferred embodiment employs a FET 98 instead of conventional bipolar transistors because a field effect transistor is characterized by higher gains and high switching speeds than bipolar transistors.

Resistor 123 provides a path for leakage currents (and noise) when the PWM 97 is in an undervoltage condition. A diode 124 is connected in series with parallel-connected resistor 125 and capacitor 126, across primary winding 158. Diode 124, resistor 125 and capacitor 126 clamp the drain voltage of FET 98 to a safe level during the off-time of the FET 98. Capacitor 127 and resistor 128, which are connected in parallel with primary winding 158, reduce high frequency ringing.

FET 98 has its source to drain circuit connected in series with the primary winding 158 of transformer 6E. The gate of the FET 98 coupled to an output of the CCM flyback converter control circuit 28. The FET 98 is driven by a drive signal produced by the CCM flyback converter control circuit 28 which controls the width of drive pulses supplied to the FET 98, and thus the conduction or time of the FET 98, as a function of the magnitude of the current flowing through the primary winding 158.

The parallel combination of current sense resistors 93-96 in the source leg of the FET 98 develop a voltage that is proportional to the current flowing through the primary winding 158 of transformer 6E.

The continuous current mode (CCM) flyback converter circuit 28 includes a pulse-width modulator (PWM) 97 which controls the “on” time of the FET 98 by adjusting the pulse width of the drive signal for the FET 98 as a function of input current and output voltage conditions for the voltage adapter. In one embodiment, PWM 97 is the type UC3842/3/4/5 Integrated Pulse Width Modulator, commercially available from Unitrode, Merrimack, N.H., 03054, and which is described in application note number U-110A which is incorporated herein by reference. The PWM 97, which in this embodiment is an eight pin device, is connected for current mode operation. Preferably, the current mode PWM 97 contains all the control circuitry required for a wide range of input voltages.

The CCM flyback converter control circuit 28 further includes capacitors 100, 105 and 106, resistors 101, 103, 104, 109 and 268 and a zener diode 174. The current sense input 99 (pin 3) of PWM 97 is connected through resistor 101 to the current sense resistors 93-96 at the source electrode of FET 98 for receiving a signal proportional to the input current flowing in primary winding 212. The input 99 (pin 3) of PWM 97 is connected also to the primary common 260 through capacitor 100, which together with resistor 101 reduce the voltage. spike on the leading edge of the input current ramp caused by the reverse recovery currents of the clamp and output rectifiers.

The output 198 (pin 6) of PWM 97 is connected through resistor 199 to the gate electrode of FET 98 for providing a drive signal for the FET 98.

The voltage input 213 (pin 7) of PWM 97 is connected via conductor 266 to an output of the AC start-up and auxiliary power circuit 26 at the emitter of a transistor 194. The reference voltage input 102 (pin 8) of PWM 97 is connected via conductor 267 to an input of the AC start-up and auxiliary power circuit 26 at the anode of a diode 196. A 5V reference voltage provided at line 102 (pin 8) of PWM 97, provides for repeat start-up delay, oscillator and chip housekeeping.

The inverting input 151 (pin 2) of PWM 97 is connected through a resistor 103 to the junction of a phototransistor 150 of opto-coupler 30 (FIG. 5) and a resistor 104 which are connected in series between conductor 266 and the primary common 260. A resistor 268 is connected between the compare input at pin 1 of PWM 97 and the inverting input 151 of PWM 97.

The timing input at pin 4 of PWM 97 is connected to an RC timing network which establishes the operating frequency for an internal oscillator of the PWM 97. The ground input pin 5 of PWM 97 is connected to the primary common 260. Capacitors 105 and 106, which are connected between respective conductors 266 and 267 and the primary common 260, provide noise bypass.

The AC start-up and auxiliary power circuit 26 includes capacitor 187, a resistor string, formed by resistors 188-192, a capacitor 193 and transistors 132 and 194. Capacitor 187 is connected between output 266 of bridge rectifier 80 and the primary common 260 to smooth the unregulated rectified voltage provide at the output of the bridge rectifier 80. The resistors 188-192 are connected in series with capacitor 193, between the output 266 of the bridge rectifier 80 and the primary common 260, to provide a DC charging path for capacitor 193 at start-up.

The auxiliary winding 212 of the transformer is connected in series with a resistor 201 and a diode 200 in parallel with capacitor 193.

The base of transistor 132 is coupled through resistors 269 and 197 and diode 196 to conductor 267 which is connected to the voltage reference output 102 of PWM 97. Transistor 132 has its collector-emitter circuit connected between the junction of resistors 191 and 192 and, the primary common. Transistor 132 is normally non-conducting and is biased “on” to shunt the startup current source when there is an overcurrent condition to protect PWM 97.

The collector-emitter circuit of transistor 194 is connected in parallel with the auxiliary winding 212 of the transformer. The base of transistor 194 is connected to the junction of zener diode 202 and resistor 195, which are connected in series between the cathode of diode 200 and the primary common 260, which regulate the voltage at the base of transistor 194 to limit the voltage at pin 213 of PWM 97 to about 17.3 volts DC.

Referring also to FIG. 4, the secondary windings 209 of the transformer are connected between the anode of one diode 274 of dual switching diode 159 and the secondary common 261. The cathode of diode 274 is connected to the input at node 275 of the DC filter and output circuit 44. The DC filter and output circuit 44 includes storage capacitors 160-166 which are connected effectively between DC voltage output busses VO+250 and VO−251. The switching diode 159 functions as an isolating device that provides isolation between the output of the AC to DC converter and the output of the DC to DC converter at the input to the DC output and filter circuit 44.

Referring to FIGS. 4 and 7, in another embodiment, the isolating switching function provided by switching diode 159 can be provide by a pluarlity of diodes. In one embodiment, the plurality of diodes includes a first set of four diodes 400-404 and a second set of two diodes 405-406. The first set of four diodes 401-404 is connected in parallel to each other, wherein the anodes of the first set of four diodes 401-404 are commonly coupled to the secondary windings 209 of the transformer at line 255 and the cathodes of the first set of four diodes 401-404 are commonly connected to the input at node 275 of the DC filter and output circuit 44. Similarly, the second set of two diodes 405-406 are also connected in parallel, wherein the anodes of the second of two diodes 405-406 are commonly coupled to line 272 and the cathodes of the second of two diodes 405-406 are commonly connected to the input at node 275 of the DC filter and output circuit 44. The first set of four diodes 401-404 may be provided by two separate silicon packages, 407 and 408. The second of two diodes 405-406 may be provided by one silicon package 409.

DC Section Components

Referring to FIG. 4, the DC input filter 32 is connected between the DC input 12 and the DC enable circuit 34. The DC input filter 32 includes a metal oxide varistor (MOV) 78, an inductor 76, and capacitors 75 and 77, connected to form a pi filter. The DC input filter 32 guards against potentially damaging voltage spikes.

In one embodiment, the DC enable circuit 34 is a field effect transistor (FET) 88, preferably a low voltage MOSFET that has its source-to-drain circuit connected between the output of the DC input filter 32 at node 70 and the input of the VMB converter 36 at node 271. The FET 88 acts a switch that is controlled to isolate the DC input from, or connect the DC input to the VMB converter 36 as a function of voltage or current conditions for the DC section 29.

The VMB converter 36 includes a field effect transistor (FET) 115, resistor 129, and a boost inductor 170. The boost inductor 170 is connected between the output of FET 88 at node 271 and conductor 272 at the drain electrode of FET 115. The source-to-drain circuitry FET 115 is connected between conductor 272 and the secondary common 261. The VMB converter 36 converts the input DC voltage to a higher output voltage. To this end, FET 115 is operated as a switch that is turned on- and off, cyclically, by the VMB converter control circuit 38 (FIG. 5), grounding terminal of the boost inductor 170 to the secondary common 261, allowing the conductor to store energy. The energy is transferred via conductor 272 and diode 276 of the dual switching diode 159 to the DC filter and output circuit 44. Resistor 129 provides a path for leakage currents (and noise) when the PWM 107 is in an undervoltage condition. As is stated above, the dual switching diode 159 functions as an isolating device that provides isolation between the output of the AC to DC converter and the output of the DC to DC converter at the input to the DC output and filter circuit 44.

Referring to FIG. 5, the heart of VMB control circuit 38 is PWM 107 which is used in conjunction with the DC feedback circuit 45 and the AC feedback circuit 46 to regulate DC voltage provided by the voltage adapter. Capacitor 120 and capacitor 121 are noise filters. Clamping diode 122 clamps the voltage at the inverting input 153 (pin 2) to less that the voltage at V_{ref} (pin 1) plus 0.7 V.

The voltage mode boost (VMB) converter circuit 38 includes PWM 107 which controls the “on” time of the FET 115 by adjusting the pulse width of the drive signal for the FET 115 as a function of input current and output voltage conditions for the voltage adapter. In one embodiment, PWM 107 is the type UC3842/3/4/5 Integrated Pulse Width Modulator, commercially available from Unitrode. The PWM 107, which in this embodiment is an eight pin device, is connected for voltage mode operation. The VMB converter control circuit 38 further includes capacitors 112, 114 and 119-121, resistors 109-111, 113, 116-118 and 278 and a zener diode 176 and diode 122.

The voltage input at pin 7 of PWM 107 is connected via conductor 286 and resistor 273 to the output, at node 270, of the switching FET 88. Referring also to FIG. 4, when FET 88 is turned on, DC voltage is extended through resistor 273 and conductor 286 to pin 7, powering on the PWM.

The output 198 (pin 6) of PWM 107 is connected through resistor 116 and conductor 253 to the gate electrode of FET 115 (FIG. 4) for providing a drive signal for the FET 115. The drive signal causes the FET 115 to conduct periodically for switching to ground (i.e., secondary common 261) conductor 272 and the terminal of the boost inductor 170 that is connected to conductor 272.

The current sense input 108 (pin 3) of PWM 107 is connected to a voltage divider formed by resistors 109 and 110 which are connected in series between conductor 267 and the secondary common 261. The voltage divider provides a bias voltage at about 0.5 volts DC at the current sense input pin 3 of the PWM 107.

The reference voltage output at pin 8 of PWM 107 is connected to conductor 267.

The inverting input 153 (pin 2) of PWM 107 is connected through resistor 118 and via conductor 254 to the output of the DC feedback circuit 45 at the emitter of transistor 152. Diode 122 is connected between conductor 287 and the inverting input 153 to prevent the voltage at the inverting input (pin 2) from exceeding the sum of the voltage on conductor 287, (i.e., the voltage at voltage reference input pin 8) and 0.5 volts DC. The gain of the internal error amplifier is set at −1 with resistors 117 and 118.

A voltage reference circuit formed by zener diode 176 and resistor 278, which are connected between the output bus V0+ and the secondary common 261, raises the input voltage at the inverting input at pin 2, turning off the PWM 107, whenever the DC output voltage appearing between output bus VO+ and output bus VO− increases to a value greater than 26.5 volts. Capacitor 119 provides a pole for the output capacitor equivalent series resistance (ESR) zero.

The timing input at pin 4 of PWM 107 is connected to an RC timing network, including resistor 111 and capacitor 112, which are connected between conductor 287 and the secondary common 261, establishes the operating frequency for an internal oscillator of the PWM 107. A portion of the timing ramp is coupled through capacitor 114 and resistor 113 to the current sense input at pin 3. The ground input pin 5 of PWM 107 is connected to the secondary common 261. Capacitors 120 and 121, which are connected between respective conductors 287 and 286 and the secondary common 261, provide noise bypass.

The DC input over/under voltage control 40 includes a quad comparator circuit 84 with support circuitry to make it stable. The quad comparator 84 includes comparator sections 281, 282, 283, and 284. The DC input over/under voltage control 40 further includes resistor divider 177-178, reference rectifier 136, a resistor 185, dual switching diode 144, and a dual switching diode 186.

Resistive divider network 177-178 and comparator sections 281-283 sense the amplitude of the input DC voltage. A tap 281 of resistive divider network 177-178 is connected to the inverting pin 4 (line 179) of comparator section 283. A 2.5 volt DC reference voltage is supplied to non-inverting input, pin 5 (line 181), of comparator section 283 by reference rectifier 136.

Resistor 185 is connected between the non-inverting input, pin 5 (line 181), of comparator section 283 and the anode of one diode 282 of dual switching diode 186, the cathode of which is connected to the output, pin 2 (line 184), of comparator section 283. The other diode 283 of dual switching diode 186 is connected between the non-inverting input, pin 9 (line 182), of comparator section 281 and the output, pin 2 (line 184), of comparator section 283.

The DC output overcurrent/short circuit protection circuit 48 also uses the same quad comparator (84) to provide over/under voltage control 40. The DC output overcurrent/short circuit protection circuit 48 further includes sensing resistor 133 (FIG. 4), a resistor divider network formed by resistors 134 and 135, and a resistor divider network formed by resistors 139 and 140. The output resistor 133 (FIG. 4) provides a voltage drop which is proportional to the output current. The two resistor divider networks, connected to opposite sides of the sensing resistor 133, monitor the current in the output current by monitoring the voltage drop across the resistor 133.

The resistor divider network consisting of resistor 134 and 135 is connected across a 2.5 volt reference voltage provided by zener diode 136 and is grounded to the negative side of resistor 133 through its connection to the secondary common 261. The tap 284 of resistor divider network 134 and 135 is connected to the non-inverting pin 7 (line 138) of comparator section 284.

The resistor divider network formed by resistors 139 and 140 is connected across the DC output busses VO+ and VO− and is grounded to the output return or positive side of resistor 133. The tap 285 of divider resistive network 139 and 140 is connected to the inverting pin 6 (line 141) of comparator section 284.

Referring to FIG. 5, the AC feedback and softstart circuit 46 produces a feedback that is coupled to the AC section 27 by opto-coupler 30. The feedback signal portion of the AC feedback and softstart circuit 46 includes resistors 154-155, a potentiometer 156, and an adjustable reference rectifier 157.

Resistors 154-155 are connected in series with potentiometer 156 across the DC output busses VO+ and VO−, forming a voltage divider, which samples the DC output voltage. The tap 286 of the resistive divider is connected to the input pin 1 (line 211) of the adjustable reference rectifier 157 which is connected in series with resistors 141, 148 and the diode portion 147 of opto-coupler 30 between the DC output busses VO+ and VO−. The function of the AC feedback and softstart circuit is to provide feedback to the PWM 97 for regulation and to provide a constant DC output voltage by smoothing ripples in the source voltage and the variations in the load current.

Referring to FIGS. 3 and 4, the opto-coupler 30 is connected to couple feedback signals from the DC section 29 to the AC section 27 for regulating a DC output voltage derived from an AC input voltage. Opto-coupler 30 is a sealed self-contained unit consisting of a light emitting diode (LED) portion 147, shown in FIG. 5, and a phototransistor portion 150, shown in FIG. 3. The opto-coupler 30 produces a feedback signal for causing the PWM 97 to reduce the width of the drive pulse for FET 98 whenever the amplitude of the Dc output voltage rises above a selected value.

Referring to FIG. 4. the DC output and filter circuit 44 includes an inductor 166, a first bank of capacitors 160-162, and a second bank of capacitors 163-165 which are connected effectively in parallel between the DC output bus V0+ and the DC output bus V0−. The DC output further includes an indicator LED 215 which is connected in series with current limiting resistors 148 and 203 across the DC outputs V0+ and V0− for indicating when a DC output voltage is being provided by the voltage adapter 10.

The output of the AC to DC converter at node 255 is coupled to the DC voltage output and filter circuit 44 through diode 274 of dual switching diode 159. Capacitor 167, capacitor 168 and resistor 169 comprise a snubber for dual switching diode 159 at the output of the AC to DC converter. Similarly, the output of the DC to DC converter is coupled to the DC voltage output and filter circuit 44 through the other diode 276 of dual switching diode 154. Inductor 166 is a smoothing choke to reduce output ripple and noise. Capacitor 171, capacitor 172 and resistor 173 comprise a snubber for the dual switching diode 159 at the output of the DC to DC converter.

### Operation

If the input source is the AC Source 23, then AC-to-DC Converter (FIGS. 3-4) (including the continuous current mode flyback converter 24 and the control circuit 28) is used as the front-end converter for the voltage adapter 10. The AC Source 23 is rectified by full bridge rectifier 80 to get an uncontrolled DC, and then a DC-to-DC converter is used to get a controlled DC output (FIG. 4).

If the input source is the DC Source 21, the DC-to-DC converter, shown in FIGS. 4-5 regulates the DC input voltage.

Considering first the case where an AC input voltage from AC source 23 is being supplied to the voltage adapter 10.

Startup

Referring to FIG. 3, when AC is first applied, the AC voltage is passed though the EMI filter and is rectified by full bridge rectifier 80. The AC voltage is then smoothed by capacitor 187. Initially, transistors 132 and 194 are non-conducting. The resistors 188-192 provide DC charging current to capacitor 193. This causes series-pass transistor 194 to conduct as the result of base current provided by resistor 195. When transistor 194 conducts, most of the voltage on capacitor 193 to appear at line 213 (pin 7) of PWM 97. When the voltage reaches about 16 VDC, PWM 97 starts switching and discharging capacitor 193. The 5 volt reference of PWM 97 (line 102 of pin 8) comes up, thereby charging capacitor 130 through rectifier diode 196 and resistor 197. When capacitor 130 gets to about 2.5 Volts, transistor 132 turns on and takes the junction of resistor 191 and resistor 192 near ground. This shunts the start-up current source to help delay turn-on when in an overcurrent condition. The output of PWM 97 (line 198—pin 6) drives the gate of FET 98 through resistor 199. As FET 98 drives the primary of transistor 158, current coupled to the auxiliary winding 212 of the transformer from the primary winding 158 replenishes the charge on capacitor 193 via rectifier diode 200 and resistor 201. If the output voltage is adjusted towards 24.5 VDC, the voltage on capacitor 193 increases in the same proportion. The zener diode 202 regulates the base of transistor 194 at 18 VDC, thus the amplitude of the voltage at voltage input, line 213 (pin 7), of PWM 97 cannot increase to more than about 17.3 VDC.

AC EMI Filter

The EMI filter of the voltage adapter reduces the amount of radiated noise escaping out the line cord. Referring to FIGS. 3, for an AC input, the by-pass capacitor 70 reduces the common mode conducted emissions. The capacitor 71 reduces differential mode noise. The common core chokes 72 and 73 minimize both common mode and differential mode noise.

AC In-rush Limiting

For an AC input, shown in FIG. 3, input surge current into bridge rectifier 80 is limited by thermistor 79.

AC Pulse-width Modulation

Referring to FIG. 3, in the preferred embodiment, PWM 97 controls the pulse width to the FET 98 by comparing the primary current ramp (at pin 3) via sense resistors 93, 94, 95, and 96 to an error signal generated by the opto-coupler 30 (phototransistor 150) and adjustable reference diode 151. If the voltage at pin 3 (line 99) of PWM 97 rises above 1 V (4.0 A primary current), the PWM 97 shuts down for that switching cycle.

The PWM 97 senses the output at the secondary through the feedback circuitry 46 and turns the FET 98 on and off according to the level of the voltage or current. By switching the FET 98 on and off very rapidly the energy stored in the transformer primary can be regulated to provide a constant voltage output. Hence, in the preferred embodiment of the voltage adapter 10, regulation is not needed after the AC to DC converter output because of the use of PWM 97.

AC Current Limiting

Referring to FIG. 3, which illustrates the AC input current limiting, the current sense resistors 93, 94, 95, and 96 in the source leg of FET 98 develop a voltage that is proportional to the thermistor 79 primary current. This is monitored by the PWM 97 via resistor 101 into line 99 (pin 3) of PWM 97. If the output draws too much energy (i.e. more primary current), the voltage at line 99 (pin 3) will exceed 1 V peak, and the PWM 97 will start to decrease the pulse width to FET 98. Eventually, the pulse width decreased sufficiently to reduce the voltage on the auxiliary winding 212 that supports the PWM 97 operation. The FET 98 shuts off, but initially, the voltage of capacitor 130 keeps transistor 132 on.

The start-up current is shunted away from the PWM 97 until capacitor 130 is discharged. Then PWM 97 tries to start again. If the overload condition still exists, the process repeats. Otherwise, PWM 97 starts normally. Flybacks transfer energy to the output when the switching device is off. Therefore, primary current limiting does not exactly reflect what is going on in the secondary.

For added protection, a secondary detection scheme is employed. Resistor 133, shown in FIG. 4, has a voltage drop proportional to the output current. Two resistive divider networks, resistors 134-135 and resistors 139-140, monitor this drop. When the output current exceeds its rating, the drop across resistor 133 causes pin 7 at line 138 of quad comparator section 84 to drop below pin 6 (line 141) of quad comparator section 284. The output pin 1 (line 142) of quad comparator section 284 goes low and discharges the soft-start capacitor 143 through diode of dual switching diode 144 and resistor 145. This eventually pulls the base of transistor 146 low, turning it on. Consequently, the LED portion 147 of opto-coupler 30 is now driven hard via resistor 148, 149, and, through the transistor portion 150 of opto-coupler 30 (shown in FIG. 3), the line 151 (inverting pin 2) of PWM 97 is driven high, which shuts down the PWM 97 output.

AC Regulation

Referring to FIGS. 3-5, if the output voltage rises, the voltage to the input pin 1 (line 211) of adjustable reference rectifier 157 increases, causing the cathode 2 (line 210) of adjustable reference rectifier 157 to pull more current through the LED portion 147 of opto-coupler 30. The transistor portion 150 (FIG. 3) of opto-coupler 30, turns on harder, raising the voltage to the line 151 (inverting pin 2) of PWM 97. The pulse width cuts back slightly, and the output drops to its normal value.

The main FET 98, shown in FIG. 3, switches the primary winding of transformer 158 at about 100 kHz. When the FET 98 turns off, energy stored in the core is transferred to the secondary windings, and one half of dual switching diode 159, conducts (the other half is used during DC input conversion), charging the output capacitors, consisting of capacitor 160, capacitor 161, capacitor 162, capacitor 163, capacitor 164 and capacitor 165.

AC Voltage Protection

Referring to FIG. 3, the overvoltage protection circuit for the AC input is shown. If a fault occurs in the power supply that causes the output voltage to be driven too high, the transformer causes the voltage appearing across the auxiliary winding 212 to rise proportionately. Zener diode 174 conducts and raises the voltage to the inverting input of the PWM 97, shutting it down. In the event of an externally applied voltage or a fault in the secondary that does not reflect back through transformer 209, zener diode 175 clamps the base of transistor 146 at 27 V. As the output voltage increases, the emitter of transistor 146 rises and transistor 146 turns on, increasing the current in the opto-coupler's 30 LED 147. This drives the inverting pin 2 (line 153) of PWM 107 higher, and shutting off the PWM 107.

The following is a description of the operation of the voltage adapter 10 when a DC input voltage from DC source 21 is being supplied to the voltage adapter 10.

DC EMI Filter

Referring to FIGS. 4 and 5, the pi-type filter, consisting of capacitor 75, inductor 76 and capacitor 77, and MOV 78 provide EMI filtering and transient protection for DC input.

DC In-rush Limiting

Referring to FIG. 5, when a DC source is applied, the DC input voltage, after filtering, is sensed by the current divider consisting of resistor 81 and resistor 82. If the voltage appearing at pin 14 of comparator section 281 is greater than 9 volts DC, pin 83 of quad comparator section 84 releases, and capacitor 85 begins to charge. After about 0.9 seconds, the voltage on capacitor 85 has reached the threshold at which pin 13 (line 86) of quad comparator section 84 switches low. This turns on the FET 88. The gate charge of FET 88, together with resistor 90 and R_{DSon} of FET 88, limit the surge current. After FET 88 is turned on, PWM 107 is powered on and starts driving the boost FET 115 via output at line 214 (pin 6) of PWM 107 through resistor 116.

DC Pulse-width Modulation

Referring again to FIG. 5, similar to the AC input supply, the DC input supply is regulated by PWM 107. The output 198 (pin 6) of PWM 107 is connected through resistor 116 and conductor 253 to the gate electrode of FET 115 (FIG. 4) for providing a drive signal for the FET 115 for causing the FET 115 to conduct periodically for switching to ground conductor 272 and the terminal of the boost inductor 170 that is connected to conductor 272. FET 115 switches terminal of the boost inductor 170 to ground at the rate of about 50 kHz. The other diode of dual switching diode 159 is used as the boost diode. When FET 115 turns on to store energy in the boost inductor 170, diode of the dual switching diode 159 is reverse biased, thus keeping the output circuit of the voltage adapter from being shorted to ground. When FET 115 turns off, the energy stored in the boost inductor 170 is transferred through diode of the dual switching diode 159 to the output capacitors 160-165 to replenish the charge on the output capacitors.

DC Current Limiting

Referring to FIG. 5, input current limiting for DC input is performed with the same circuit as the secondary scheme mentioned above. When transistor 146 turns on, transistor 152 turns on, driving the inverting pin 2 (line 153) of PWM 107 high. When quad comparator section 84 pulls low, the other diode of dual switching diode 144 pulls down on the non-inverting pin 9 (line 182) of quad comparator section 84. This causes FET 88 to shut off which removes the DC bulk voltage to the boost circuit. Capacitor 85 has to charge up again before PWM 107 starts switching.

DC Regulation

Referring to FIG. 5, the DC input regulation scheme uses most of the same secondary feedback circuitry as the AC input. Rectifier 157 turns on transistor 152 and transistor 152 drives the inverting pin 2 (line 153) of PWM 107 higher.

The main FET 115 switches terminal of the boost inductor 170 to ground at about 50 kHz. The other half of dual switching diode 159 is used as the boost diode. When FET 115 turns on to store energy in the boost inductor 170, dual switching diode 159 is reverse biased, thus keeping the output circuit of the voltage adapter from being shorted to ground. When FET 115 turns off, the energy stored in the boost inductor 170 is transferred through dual switching diode 159 to the output capacitors to replenish the charge on the output capacitors.

DC Voltage Protection

Referring to FIG. 5, DC voltage protection is shown with the zener diode 176 connected from the output nearly directly to the inverting input at line 153 (pin 2) of the PWM 107. If the output voltage increases above about 26.5 V, zener 176 turns on and raises the inverting input voltage at line 153 (pin 2) of PWM 107, thereby turning off the PWM 107. For input protection, the divider resistive network, consisting of resistor 177 and 178, senses the DC input voltage after the EMI filter. When the DC input voltage at input 13 exceeds about 16.2 V, the output pin 2 (line 184) of quad comparator section 84 goes low, pulling down pin 9 (line 182) of quad comparator section 84 and its own hysteretic resistor 185 through dual switching diode 186. FET 88 is turned off and the DC output voltage goes to zero.

Selectable DC Output Voltage

Referring to FIG. 4; potentiometer 156 allows for selecting the magnitude of the DC output voltage by providing means for adjusting the resistive value at the DC output, thereby adjusting the set point. In one embodiment, the voltage adapter 10 employs a potentiometer for adjusting the amplitude of the regulated DC output voltage, to a value in a range of between 15 volts to 25 volts.

In another embodiment, the voltage adapter 10 can include a manually adjustable trim pot (not shown) for adjusting the amplitude of the DC output voltage. The trim pot can be a digitally adjustable resistor. The trim pot can be connected in the feedback loop of a DC-DC converter, and changing the value of the trim pot causes a corresponding change in the amplitude of the regulated DC output voltage produced by the converter adapter 10. This is especially useful in instances where a microprocessor operates at a low voltage to save power, and then operates at a high voltage for increased processing power. Switching between these operating modes requires adjusting the output voltage of a DC-DC converter.

Alternatively, the DC output voltage can be controlled and adjusted at the booster portion of the voltage adapter rather than at the output portion of the voltage adapter. In this case, the selectable feature is the output level of the DC-DC converter or the gain of the DC-DC converter.

In the preferred embodiment, the magnitude of the DC output voltage is pre-selected at the time the voltage adapter is manufactured. In another embodiment, a means for manually adjusting the DC output voltage is provided with the voltage adapter.

In another embodiment, an analog or digital means is provide to facilitate the selection of the DC output voltage. The analog means may include a rotary dial with varying resistive elements of different values, thereby mimicking the operation of the potentiometer 156 of the preferred embodiment. The digital means may include an A/D support circuitry to help the user adjust the DC output voltage and a visual readout support circuitry to help the user read the DC output voltage. The visual readout support circuitry may include a digital readout LED or a liquid crystal display (LCD). In the preferred embodiment, the digital readout is at least a 2-digit display.

It may therefore be appreciated from the above detailed description of the preferred embodiment of the voltage adapter 10 that it provides a single-output isolated continuous current mode flyback converter for the AC input and a voltage mode boost converter for the DC input. In the preferred embodiment, the voltage adapter 10 provides a power supply and cable assemblies that can electrically couple DC operable devices to AC or DC voltage source to provide DC power to the DC operable devices. In an alternate embodiment, a single cable assembly can be capable of electrically coupling the power supply to an AC or DC voltage source.

The preferred embodiment also features EMI AC input filter, bridge rectifier and bulk voltage storage, primary continuous current mode flyback converter, AC start-up and auxiliary power, continuous current mode flyback converter control circuit, and opto-coupler, DC input filtering, FET switch, voltage boost converter, voltage mode boost converter control circuit, DC input over and under voltage control, secondary continuous current mode flyback converter, output capacitors and filtering, AC feedback and softstart, output current and short circuit protection, and selectable DC output voltage.

Although an exemplary embodiment of the voltage adapter 10 has been shown and described with reference to particular embodiments and applications thereof, it will be apparent to those having ordinary skill in the art that a number of changes, modifications, or alterations to the invention as described herein may be made, none of which depart from the spirit or scope of the voltage adapter 10. All such changes, modifications, and alterations should therefore be seen as being within the scope of the voltage adapter 10.

What is claimed is:

1. A voltage delivery system for use with a DC voltage operable device and a remote voltage power source, comprising:
a voltage adapter for deriving a DC output voltage from either an AC voltage power source or a DC voltage power source
a first cable assembly for electrically coupling said voltage adapter to said DC voltage power source;
a second cable assembly for electrically coupling said voltage adapter to assembly AC voltage power source; and
a third cable assembly for electrically coupling said voltage adapter to said DC voltage operable device, said voltage adapter including a first voltage regulator for regulating a DC output voltage derived from the AC voltage and a second voltage regulator for regulating a DC output voltage derived from the DC voltage.

2. The voltage delivery system according to claim 1, wherein said voltage adapter further comprises a feedback circuit for deriving from said DC output voltage feedback signal for controlling said first voltage regulator and said second voltage regulator.

3. The voltage delivery system according to claim 1, wherein said first voltage regulator includes a first switching device and a first pulse-width modulator for providing a drive signal for said first switching device and said second voltage regulator includes a second switching device and a second a pulse-width modulator for providing a drive signal for said second switching device.

4. The voltage delivery system according to claim 1, wherein said voltage adapter further comprises a DC output circuit portion adapted to allow the selection of the amplitude of the DC output voltage.

5. The voltage delivery system according to claim 4, wherein said voltage adapter further comprises an overvoltage protection portion for disabling at least one of said voltage regulators whenever the amplitude of the DC output voltage exceeds a pre-determined value.

6. The voltage delivery system according to claim 3, wherein said voltage adapter further comprises a common feedback circuit for deriving from said DC output voltage, feedback signals for said first pulse-width modulator and said second pulse-width modulator.

7. The voltage delivery system according to claim 1, wherein said voltage adapter further includes a voltage boosting converter portion for boosting the amplitude of a DC input voltage from said DC voltage power source to a higher amplitude in deriving said DC output voltage.

8. The voltage delivery system according to claim 1, wherein said voltage adapter further comprises a first in-rush current limiter for reducing in-rush current due to AC input voltage and a second in-rush current limiter for reducing in-rush current due to DC input voltage.

9. The voltage delivery system according to claim 1, wherein said DC output circuit allows selection of the amplitude for the DC output voltage within a range of about 15 volts DC to 25 volts DC.

10. A voltage delivery system for use with a DC voltage operable device and a remote voltage power source, comprising:
a voltage adapter for deriving a DC output voltage from either an AC voltage power source or a DC voltage power source
a first cable assembly for electrically coupling said voltage adapter to said DC voltage power source;
a second cable assembly for electrically coupling said voltage adapter to assembly AC voltage power source;
a third cable assembly for electrically coupling said voltage adapter to said DC voltage operable device;
said voltage adapter including a first voltage regulator for regulating a DC output voltage derived from the AC voltage and a second voltage regulator for regulating a DC output voltage derived from the DC voltage;
a DC output circuit; and
a switching device interposed between said first and second voltage regulators and said DC output circuit for selectively extending said first and second regulated voltages to said DC output circuit.

11. The voltage delivery system according to claim 10, wherein said voltage adapter further comprises a feedback circuit for deriving from said DC output voltage feedback signal for controlling said first voltage regulator and said second voltage regulator.

12. The voltage delivery system according to claim 10, wherein said first voltage regulator includes a first switching device and a first pulse-width modulator for providing a drive signal for said first switching device and said second voltage regulator includes a second switching device and a second a pulse-width modulator for providing a drive signal for said second switching device.

13. The voltage delivery system according to claim 10, wherein said voltage adapter further includes a DC output voltage amplitude selection circuit adapted to allow the selection of the amplitude of the DC output voltage.

14. The voltage delivery system according to claim 13, wherein said voltage adapter further comprises an overvoltage protection portion for disabling at least one of said voltage regulators whenever the amplitude of the DC output voltage exceeds a pre-determined value.

15. The voltage delivery system according to claim 13 wherein said DC output voltage amplitude selection circuit includes a variable resistance device.

16. The voltage delivery system according to claim 12, wherein said voltage adapter further comprises a common feedback circuit for deriving from said DC output voltage, feedback signals for said first pulse-width modulator and said second pulse-width modulator.

17. The voltage delivery system according to claim 10, wherein said voltage adapter further includes a voltage boosting converter portion for boosting the amplitude of a DC input voltage from said DC voltage power source to a higher amplitude in deriving said DC output voltage.

18. The voltage delivery system according to claim 10, wherein said voltage adapter further comprises a first in-rush current limiter for reducing in-rush current due to AC input voltage and a second in-rush current limiter for reducing in-rush current due to DC input voltage.

19. The voltage delivery system according to claim 10, wherein said DC output circuit allows selection of the amplitude for the DC output voltage within a range of about 15 volts DC to 25 volts DC.

20. The voltage delivery system according to claim 16 wherein said voltage adapter includes an opto-coupling device for coupling a feedback signal from a feedback circuit to one of said voltage regulators.

21. A voltage delivery system for use with a DC voltage operable device and a remote voltage power source, comprising:
a voltage adapter for deriving a DC output voltage from either an AC voltage from said AC voltage power source or a DC voltage from said DC voltage power source,
a first cable assembly capable of electrically coupling said voltage adapter to a DC voltage power source or an AC voltage power source; and
a second cable assembly for electrically coupling said voltage adapter to said DC voltage operable device, said voltage adapter including a DC output circuit portion adapted to allow the selection of the amplitude of the DC output voltage.

22. The voltage delivery system according to claim 21, wherein said voltage adapter further comprises a voltage regulator for regulating the DC output voltage, said voltage regulator includes a switching device and a pulse-width modulator for providing a drive signal for said switching device.

23. The voltage delivery system according to claim 22, wherein said voltage adapter further comprises a feedback circuit for deriving from said DC output voltage, a feedback signal for said voltage regulator.

24. The voltage delivery system according to claim 21, wherein said voltage adapter further comprises a first voltage regulator for regulating a DC output voltage derived from the AC voltage and a second voltage regulator for regulating a DC output voltage derived from the DC voltage.

25. The voltage delivery system according to claim 24, wherein said first voltage regulator includes a first switching device and a first pulse-width modulator for providing a drive signal for said first switching device and said second voltage regulator includes a second switching device and a second a pulse-width modulator for providing a drive signal for said second switching device.

26. The voltage delivery system according to claim 21, wherein said DC output circuit allows selection of the amplitude for the DC output voltage within a range of about 15 volts DC to 25 volts DC.

27. A dual input voltage adapter for use with a DC voltage operable device, said dual input voltage adapter comprising:
means for electrically coupling said dual input voltage adapter to an AC voltage power source;
means for electrically coupling said dual input voltage adapter to a DC voltage power source;
means for electrically coupling said dual input voltage adapter to a DC voltage operable device;
means for deriving a DC output voltage from either said AC voltage power source or DC voltage power source for delivering the DC output voltage to said DC operable device; and
means for selecting the amplitude of the DC output voltage.

28. The voltage adapter according to claim 27, further comprising means for regulating the DC output voltage.

29. The voltage adapter according to claim 27, further comprising means for deriving from said DC output voltage, a feedback signal for controlling said voltage regulator.

30. The voltage adapter according to claim 27, further comprises first means for regulating the AC voltage and second means for regulating the DC voltage.

31. The voltage adapter according to claim 27, further comprising means for boosting the amplitude of a DC input voltage from said DC voltage power source to a higher amplitude in deriving said DC output voltage.

32. A method of supplying DC voltage to a DC operable device, said method comprising the steps of:
selectively coupling a cable assembly from a voltage adapter to either a DC voltage power source or an AC voltage power source;
coupling said voltage adapter to said DC voltage operable device; and
regulating a DC output voltage derived from the AC voltage using a first voltage regulator and regulating a DC output voltage derived from the DC voltage using a second voltage regulator.

33. The method according to claim 32, said method further comprising the steps of selecting an amplitude for the DC output voltage and delivering the selected DC output voltage to said DC voltage operable device.

34. The method according to claim 32, said method further comprising the step of deriving from said DC output voltage, feedback signals for said first voltage regulator and said second voltage regulator.

35. The method according to claim 32, and further comprising optically coupling a feedback signal from a feedback circuit to one of said voltage regulators.
